(19) United States
(12) Patent Application Publication
(10) Pub. No.: US 2025/0035806 A1
(43) Pub. Date: Jan. 30, 2025

(54) SEPARATED MULTI-CORE TRANSMITTING DEVICES BASED ON GROUND TRANSIENT ELECTROMAGNETIC METHODS

(71) Applicant: CHINA UNIVERSITY OF MINING AND TECHNOLOGY, Xuzhou, Jiangsu (CN)

(72) Inventors: Haiyan YANG, Xuzhou (CN); Jianhua YUE, Xuzhou (CN); Zhixin LIU, Xuzhou (CN); Wenyu LI, Xuzhou (CN); Yanyan GU, Xuzhou (CN); Rongqi CHE, Xuzhou (CN); Yunlei XU, Xuzhou (CN); Zhenyang LI, Xuzhou (CN); Menglang SUN, Xuzhou (CN); Huageng RAN, Xuzhou (CN)

(73) Assignee: CHINA UNIVERSITY OF MINING AND TECHNOLOGY, Xuzhou, Jiangsu (CN)

(21) Appl. No.: 18/586,392

(22) Filed: Feb. 23, 2024

(30) Foreign Application Priority Data
Jul. 27, 2023 (CN) 202310932432.5

(51) Int. Cl. G01V 3/08

(52) U.S. Cl. CPC G01V 3/083; G01V 2003/084

(57) ABSTRACT

Disclosed is a separated multi-core transmitting device based on a ground transient electromagnetic method, comprising: a rectangular transmitting coil enclosed by a cable I, a cable II, a cable III, and a cable IV. Each of the cable I, the cable II, the cable III, and the cable IV is provided with N wires. Two ends of each of the N wires is provided with a sub connector and a female connector, respectively. The sub connectors and the female connectors are detachably connected through sub connector interfaces and female connector interfaces. A first wire of the female connectors of the cable I is led out to serve as a positive electrode of a transient electromagnetic instrument transmitter, and a last wire of the sub connectors of the cable IV is led out to serve as a negative electrode of the transient electromagnetic instrument transmitter.

### CROSS-REFERENCES TO RELATED APPLICATIONS

This application claims priority of Chinese Patent Application No. 202310932432.5, filed on Jul. 27, 2023, the content of which is entirely incorporated herein by reference.

### TECHNICAL FIELD

The present disclosure relates to the field of transient electromagnetic technology, and in particular, to a separated multi-core transmitting device based on a ground transient electromagnetic method.

### BACKGROUND

A transient electromagnetic method (TEM) is a geophysical exploration method, which has a wide range of applications in the fields of exploration of metallic and non-metallic mineral resources, investigation of geological hazards, and detection of urban underground space. A transient electromagnetic device based on the TEM consists of a transmitting coil and a receiving probe. In the transient electromagnetic theory, achieving a deeper probing requires a larger side length of the transmitting coil or an increase of a count of transmitting coil turns. As a result, in deep probing, such as metal ore exploration, the side length of the transmitting coil may reach several hundred meters. However, in shallow probing, such as engineering exploration and urban geological survey, as limited by the ground working environment, the comprehensive ground environment, the working efficiency, and other factors, the side length of the transmitting coil may generally range from a few meters to tens of meters. To achieve a probing depth less than 200 meters, it is necessary to use a multi-turn winding method on the basis of a small side length to enhance the transmitting magnetic moment to increase the probing depth, while increasing the transmitting current to improve the signal-to-noise ratio. However, such device is a whole device of which the sides cannot be separated. When the count of turns is large, a weight may be relatively large, and the device may not be easy to move, especially in a field condition with obstacles, the device may not be deployed.

Therefore, it is desirable to provide a separated multi-core transmitting device based on a ground transient electromagnetic method, which can not only adapt to complex surface environment and solve a construction problem with great influence, such as the surface construction, vegetation, and other factors, but also improve the working efficiency.

### SUMMARY

One of the embodiments of the present disclosure provides a separated multi-core transmitting device based on a ground transient electromagnetic method, comprising: a rectangular transmitting coil. The rectangular transmitting coil may include a cable I, a cable II, a cable III, and a cable IV. Each of the cable I, the cable II, the cable III, and the cable IV may be provided with N wires. Two ends of each of the N wires may be provided with a sub connector and a female connector, respectively. The sub connectors of the wires within each cable may be labeled sequentially with uppercase letters, and the female connectors of the wires within the each cable may be labeled sequentially with lower case letters. The sub connectors may be connected with sub connector interfaces, the female connectors may be connected with female connector interfaces, and the sub connector interfaces and the female connector interfaces may be detachably connected. The sub connectors of the cable I may be connected with the female connectors of same letters of the cable II. The sub connectors of the cable II may be connected with the female connectors of same letters of the cable III. The sub connectors of the cable III may be connected with the female connectors of same letters of the cable IV. The sub connectors of the cable IV may be connected with the female connectors of next letters of same letters of the cable I. A first wire of the female connectors of the cable I may be led out to serve as a positive electrode of a transient electromagnetic instrument transmitter. A last wire of the sub connectors of the cable IV may be led out to serve as a negative electrode of the transient electromagnetic instrument transmitter.

In some embodiments, a size of the rectangular transmitting coil may be adjusted by lengths of the cable I, the cable II, the cable III, and the cable IV to adapt to different detection depths.

In some embodiments, a protective sleeve may be provided on each sub connector interface and each female connector interface, respectively.

In some embodiments, when a detection depth is 25 m, the cable I, the cable II, the cable III, and the cable IV may be cables with a length of 5 m, and a count of cable cores may be selected as 5.

In some embodiments, when a detection depth is 50 m, the cable I, the cable II, the cable III, and the cable IV may be cables with a length of 5 m, and the count of cable cores may be selected as 10; or the cable I, the cable II, the cable III, and the cable IV may be cables with a length of 10 m, and a count of cable cores may be selected as 5.

In some embodiments, when a detection depth is 100 m, the cable I, the cable II, the cable III, and the cable IV may be cables with a length of 5 m, and the count of cable cores may be selected as 20; or the cable I, the cable II, the cable III, and the cable IV may be cables with a length of 10 m, and a count of cable cores may be selected as 10.

In some embodiments, when a detection depth is 200 m, the cable I, the cable II, the cable III, and the cable IV may be cables with a length of 10 m, and the count of cable cores may be selected as 20; or the cable I, the cable II, the cable III, and the cable IV may be cables with a length of 20 m, and a count of cable cores may be selected as 10.

In some embodiments, the separated multi-core transmitting device may further comprise a control terminal and a vision sensor. The control terminal may be in communicating connection with the vision sensor. The vision sensor may be configured to acquire a current surface environment image and a coil position image after the rectangular transmitting coil is laid. The control terminal may include a processor. The processor may be configured to: determine, based on the current surface environment image, a current surface environment; determine, based on the current surface environment and a detection requirement, a laying parameter; determine, based on the laying parameter, a transmitting magnetic moment, the transmitting magnetic moment being related to a return wire area and a transmitting current; determine, based on the coil position image after the rectangular transmitting coil is laid, a coil position after the rectangular transmitting coil is laid; and correct, based on the coil position after the rectangular transmitting coil is laid, the transmitting magnetic moment.

In some embodiments, the laying parameter may include at least one of a side length of the rectangular transmitting coil, an angular point position of the rectangular transmitting coil, and a count of cable cores.

In some embodiments, the laying parameter may further include a bracket height, a bracket use, and a bracket position.

In some embodiments, the processor may be further configured to: determine, based on the current surface environment, a laying position; and determine, based on the laying position and the detection requirement, the laying parameter.

In some embodiments, the processor may be further configured to: determine, based on the laying parameter, the detection requirement, and an instrument resolution, the transmitting current through a current recommendation model. The current recommendation model may be a machine learning model.

In some embodiments, the processor may be further configured to: determine, based on the coil position after the rectangular transmitting coil is laid, an actual return wire area after the rectangular transmitting coil is laid; determine, based on the actual return wire area, a correction coefficient; and correct, based on the correction coefficient, the transmitting magnetic moment.

In some embodiments, the separated multi-core transmitting device may further comprise a bracket. The bracket may include a cable fixing member, a horizontal fixing member, support leg pivots, support legs, and a frame. The cable fixing member may be sleeved within the frame and fixedly connected with the frame through the horizontal fixing member. The support legs may be rotationally connected with a lower end of the frame through the support leg pivots.

In some embodiments, one end of the cable fixing member may be provided with an elastic member, and another end of the cable fixing member may be provided with a sleeve structure.

In some embodiments, the cable fixing member may include a first fixing member and a second fixing member. A second sleeve structure of the second fixing member may be sleeved within a first sleeve structure of the first fixing member. The first sleeve structure may be sleeved within the frame.

In some embodiments, the separated multi-core transmitting device may further comprise a height support member. The height support member may be connected with the second fixing member for adjusting a height of the second fixing member.

### BRIEF DESCRIPTION OF THE DRAWINGS

The present disclosure will be further illustrated by way of exemplary embodiments, which will be described in detail with reference to the accompanying drawings. These embodiments are not limiting, and in these embodiments, the same numbering denotes the same structure, wherein:

FIG. 1 is a schematic diagram illustrating a structure of a rectangular transmitting coil according to some embodiments of the present disclosure;

FIG. 2 is a schematic diagram illustrating a connection structure of wires according to some embodiments of the present disclosure;

FIG. 3 is a schematic diagram illustrating a sub connector and a female connector according to some embodiments of the present disclosure;

FIG. 4 is a schematic diagram illustrating a sub connector interface and a female connector interface according to some embodiments of the present disclosure;

FIG. 5 is a schematic diagram illustrating a structure of a bracket according to some embodiments of the present disclosure;

FIG. 6 is a schematic diagram illustrating an internal structure of a bracket according to some embodiments of the present disclosure;

FIG. 7 is a schematic diagram illustrating an elastic member in an A direction in FIG. 6;

FIG. 8 is a top view illustrating a cable fixing member according to some embodiments of the present disclosure;

FIG. 9 is a top view illustrating a cable fixing member after angle adjustment according to some embodiments of the present disclosure; and

FIG. 10 is a schematic diagram illustrating an exemplary current recommendation model according to some embodiments of the present disclosure.

In the figures, 1. cable I; 2. cable II; 3. cable III; 4. cable IV; 5. sub connector; 6. female connector; 7. sub connector interface; 8. female connector interface; 9. bracket; 10. a cable fixing member; 11. horizontal fixing member; 12. support leg pivot; 13. support leg; 14. frame; 15. accommodating cavity; 16. reinforcing rib; 17. elastic member; 18. sleeve structure; 19. first fixing member; 20. second fixing member; and 21. height support member.

### DETAILED DESCRIPTION

In order to more clearly illustrate the technical solutions of the embodiments of the present disclosure, the following briefly introduces the drawings that need to be used in the description of the embodiments. Apparently, the accompanying drawings in the following description are only some examples or embodiments of the present disclosure, and those skilled in the art can also apply the present disclosure to other similar scenarios according to the drawings without creative efforts. Unless obviously obtained from the context or the context illustrates otherwise, the same numeral in the drawings refers to the same structure or operation.

It should be understood that “system”, “device”, “unit” and/or “module” as used herein is a method for distinguishing different components, elements, parts, portions or assemblies of different levels. However, the words may be replaced by other expressions if other words can achieve the same purpose.

As indicated in the disclosure and claims, the terms “a”, “an” and/or “the” are not specific to the singular form and may include the plural form unless the context clearly indicates an exception. Generally speaking, the terms “comprising” and “including” only suggest the inclusion of clearly identified steps and elements, and these steps and elements do not constitute an exclusive list, and the method or device may also contain other steps or elements.

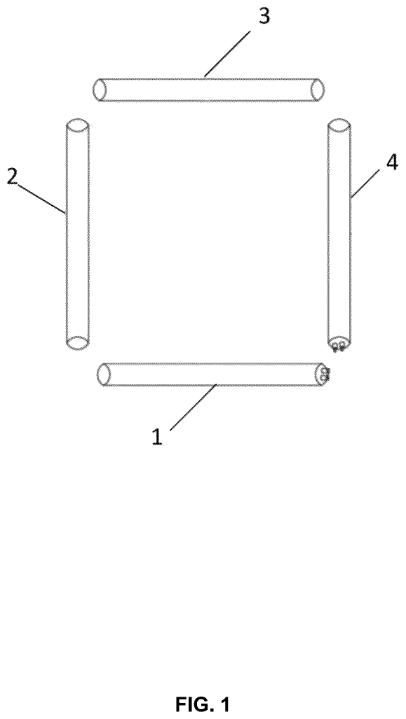

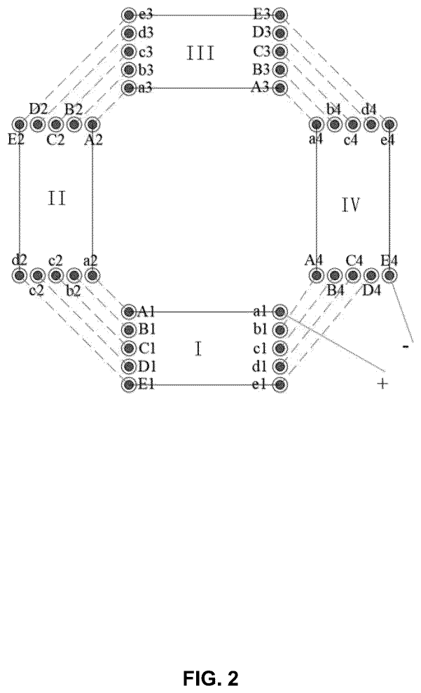

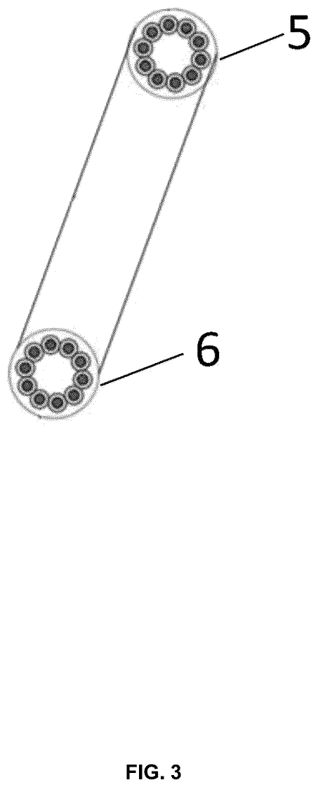

FIG. 1 is a schematic diagram illustrating a structure of a rectangular transmitting coil according to some embodiments of the present disclosure. FIG. 2 is a schematic diagram illustrating a connection structure of wires according to some embodiments of the present disclosure. FIG. 3 is a schematic diagram illustrating a sub connector and a female connector according to some embodiments of the present disclosure.

Some embodiments of the present disclosure provide a separated multi-core transmitting device (referred to as a transmitting device) based on a ground transient electromagnetic method. As illustrated in FIG. 1, the transmitting device may include a rectangular transmitting coil. The rectangular transmitting coil may include a cable I1, a cable II2, a cable III3, and a cable IV4, which form a rectangular coil. Each of the cable I1, the cable II2, the cable III3, and the cable IV4 may be provided with N wires. Two ends of each of the N wires may be provided with a sub connector and a female connector. The sub connectors of the wires within each cable may be labeled sequentially with uppercase letters, and the female connectors of the wires within the each cable may be labeled sequentially with lower case letters. The sub connectors may be connected with sub connector interfaces, the female connectors may be connected with female connector interfaces, and the sub connector interfaces and the female connector interfaces may be detachably connected. The sub connectors of the cable I1 may be connected with the female connectors of same letters of the cable II2. The sub connectors of the cable II2 may be connected with the female connectors of same letters of the cable III3. The sub connectors of the cable III3 may be connected with the female connectors of same letters of the cable IV4. The sub connectors of the cable IV4 may be connected with the female connectors of next letters of same letters of the cable I1. A first wire of the female connectors of the cable I1 may be led out to serve as a positive electrode of a transient electromagnetic instrument transmitter. A last wire of the sub connectors of the cable IV4 may be led out to serve as a negative electrode of the transient electromagnetic instrument transmitter.

Merely by way of example, as illustrated in FIG. 2 and FIG. 3, a length of each of the cable I1, the cable II2, the cable III3, and the cable IV4 may be L. Each of the cable 11, the cable II2, the cable III3, and the cable IV4 may be provided with five wires. Each of the cable I1, the cable II2, the cable III3, and the cable IV4 may be provided with sub connectors 5 and female connectors 6. Wire connectors (i.e., the sub connectors 5 and the female connectors 6) may be numbered clockwise by alphabetical symbols. The sub connectors may be labeled sequentially with upper case letters A, B, C, D, and E, and the female connectors may be labeled sequentially with lower case letters a, b, c, d, and e. Aa, Bb, Cc, Dd, and Ee may correspond to a same wire within the each of the cable I1, the cable II2, the cable III3, and the cable IV4. For example, for the cable I1, the sub connectors of the cable I1 may be numbered A1, B1, C1, D1, and E1, and the female connectors of the cable I1 may be numbered a1, b1, c1, d1, and e1. The wires of the other three cables may be numbered in the same way. A connection rule of the cable I1, the cable II2, the cable III3, and the cable IV4 may be as follows: during connection, the sub connectors of the cable I1 may be connected with the female connectors of the cable 112 based on corresponding letter numbers. That is, A1 may be connected with a2, B1 may be connected with b2, C1 may be connected with c2, D1 may be connected with d2, and E1 may be connected with e2. The sub connectors of the cable II2 may be connected with the female connectors of the cable III3 based on corresponding letter numbers. That is, A2 may be connected with a3, B2 may be connected with b3, C2 may be connected with c3, D2 may be connected with d3, and E2 may be connected with e3. The sub connectors of the cable III3 may be connected with the female connectors of the cable IV based on corresponding letter numbers. That is, A3 may be connected with a4, B3 may be connected with b4, C3 may be connected with c4, D3 may be connected with d4, and E3 may be connected with e4. The sub connectors of the cable IV4 and the female connectors of cable I1 may be connected as follows: the female connector numbered a1 of the cable I1 may be connected with the positive electrode of the transient electromagnetic instrument transmitter through a lead, and a last sub connector numbered E4 of the cable IV4 may be connected with the negative electrode of the transient electromagnetic instrument transmitter through a lead. The remaining connectors may be connected as follows: A4 of the cable IV4 may be connected with b1, B4 may be connected with c1, C4 may be connected with d1, and D4 may be connected with e1.

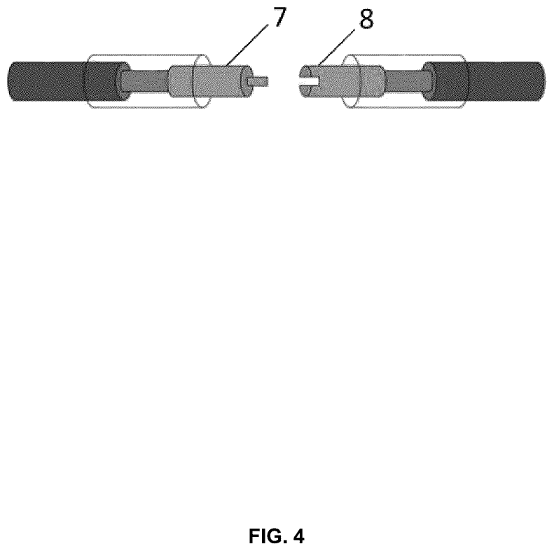

FIG. 4 is a schematic diagram illustrating a sub connector interface and a female connector interface according to some embodiments of the present disclosure. As illustrated in FIG. 4, two ends of each wire may be provided with a sub connector interface 7 and a female connector interface 8. When the cable I1, the cable II2, the cable III3, and the cable IV4 are connected in sequence, since the two ends of each of the wires of each cable are numbered with letters, connection and disassembly of the wires may be very fast and convenient based on a wiring rule described above.

In some embodiments, a protective sleeve (not shown in the figure) may be provided on each sub connector interface 7 and each female connector interface 8.

The protective sleeve may be configured to protect the interface. The protective sleeve may be made of various materials, such as insulating rubber, silicone, or the like. In some embodiments, the protective sleeve may be used to half-wrap each sub connector interface 7 and each female connector interface 8, and ends of each sub connector interface 7 and each female connector interface 8 may be exposed. It should be understood that by providing the protective sleeve, the connectors may effectively be protected from damage such as impact, bending, abrasion, or the like.

In some embodiments, a size of the rectangular transmitting coil may be adjusted by lengths of the cable I1, the cable II2, the cable III3, and the cable IV4 to adapt to different detection depths.

A detection depth refers to a maximum distance that the transmitting device is able to detect. In some embodiments, since a TEM-based transmitting device typically comprises a transmitting coil and a receiving probe, different detection depth requirements may be achieved by changing the size of the rectangular transmitting coil or a count of turns of the transmitter coil.

In some embodiments, the detection depth may be positively correlated with a cable length and a count of cable cores. A cable length refers to a side length of the transmitting coil. A cable is usually made of a plurality of metal wires or metal cables through twisting and interweaving. A count of cable cores refers to a count of metal cores (i.e., a count of wires) included in each cable. The count of cable cores may also be referred to as the count of turns of the transmitting coil.

In some embodiments, when a detection depth is 25 m, the cable I1, the cable II2, the cable III3, and the cable IV4 may be cables with a length of 5 m, and the count of cable cores may be selected as 5.

In some embodiments, when a detection depth is 50 m, the cable I1, the cable II2, the cable III3, and the cable IV4 may be cables with a length of 5 m, and the count of cable cores may be selected as 10. In some embodiments, when the detection depth is 50 m, the cable I1, the cable II2, the cable III3, and the cable IV4 may be cables with a length of 10 m, and the count of cable cores may be selected as 5.

In some embodiments, when a detection depth is 100 m, the cable I1, the cable II2, the cable III3, and the cable IV4 may be cables with a length of 5 m, and the count of cable cores may be selected as 20. In some embodiments, when the detection depth is 100 m, the cable I1, the cable II2, the cable III3, and the cable IV4 may be cables with a length of 10 m, and the count of cable cores may be selected as 10.

In some embodiments, when a detection depth is 200 m, the cable I1, the cable II2, the cable III3, and the cable IV4 may be cables with a length of 10 m, and the count of cable cores may be selected as 20. In some embodiments, when the detection depth is 200 m, the cable I1, the cable II2, the cable III3, and the cable IV4 may be cables with a length of 20 m, and the count of cable cores may be selected as 10.

Table 1 is a table of a correspondence between a detection depth estimated from a coil material and a transmitting parameter. The table provides several recommended combinations as described in some embodiments of the present disclosure, meeting the requirements of transient electromagnetic detection tasks from 25 m to 200 m. A device type may be flexibly designed based on the characteristics of different detection tasks.

TABLE 1
table of correspondence between the detection depth estimated
from the coil material and the transmitting parameter.

| | | | | | | Maximum | Maximum |
|---|---|---|---|---|---|---|---|
| | | | | | | output | output |
| | | | | | | current | current |
| | | | Count | Cross- | | for 12 V | for 24 V |
| | Detection | Cable | of | sectional | | power | power |
| Serial | depth | length | cable | area | Weight | supply | supply |
| number | (m) | (m/pcs) | cores | (mm²) | (kg) | (A) | (A) |
| 1 | 25 | 5 | 5 | 1.5 | 2.07 | 8.68 | 17.35 |
| | | | | 2.5 | 3.22 | 14.46 | 28.92 |
| 2 | 50 | 5 | 10 | 1.5 | 4.15 | 4.34 | 8.68 |
| | | | | 2.5 | 6.44 | 7.23 | 14.46 |
| | | 10 | 5 | 1.5 | 4.07 | 4.42 | 8.85 |
| | | | | 2.5 | 6.31 | 7.37 | 14.74 |
| 3 | 100 | 5 | 20 | 1.5 | 8.30 | 2.17 | 4.34 |
| | | | | 2.5 | 12.88 | 3.61 | 7.23 |
| | | | | 4 | 19.47 | 5.83 | 11.66 |
| | | 10 | 10 | 1.5 | 8.14 | 2.21 | 4.42 |
| | | | | 2.5 | 12.63 | 3.69 | 7.37 |
| | | | | 4 | 19.09 | 5.94 | 11.88 |
| 4 | 200 | 10 | 20 | 2.5 | 25.26 | 1.84 | 3.69 |
| | | | | 4 | 38.19 | 2.97 | 5.94 |
| | | 20 | 10 | 2.5 | 25.01 | 1.86 | 3.72 |
| | | | | 4 | 37.81 | 3.00 | 6.00 |

In some embodiments, a connectivity needs to be checked before the transmitting device operates. As for the cable I1, the cable II2, the cable III3, and the cable IV4, the connectivity may be checked as follows.
(1) The connectivity of each cable may be checked: whether Aa, Bb, Cc, . . . are connected may be tested using a multimeter.
(2) A connectivity of the whole device may be checked: after each cable is connected, the connectivity of a1 and E4 may be checked using the multimeter.

After the above checks are completed, an instrument may be connected for operation.

According to some embodiments of the present disclosure, by adopting separated and multi-core combination cables, a single cable is laid first, and then the rectangular transmitting coil is formed by connection, so that the separated multi-core transmitting device is fully applicable to complex surface and terrain environments, minimizes the construction problems caused by surface construction, terrain cutting, vegetation and other factors, and supports different required detection depths in terms of transmitting energy, wireframe area, and transmitting current. The connection of the transmitting coil adopts the design of sub-female connectors, which can quickly form the transmitting device based on the interface numbers, and achieve high working efficiency. In addition, some embodiments of the present disclosure may generate several combinations based on the detection depth requirements, thereby determining the optimal form of the device combined with the actual working conditions and the requirements of the transmitting parameter, and providing various optional solutions.

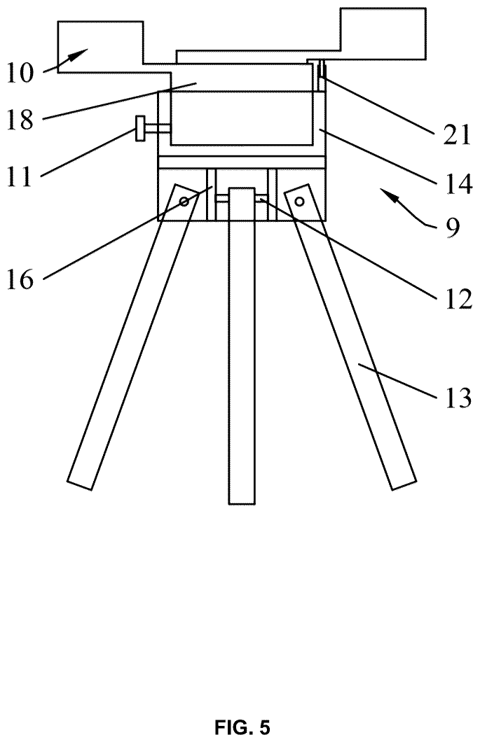

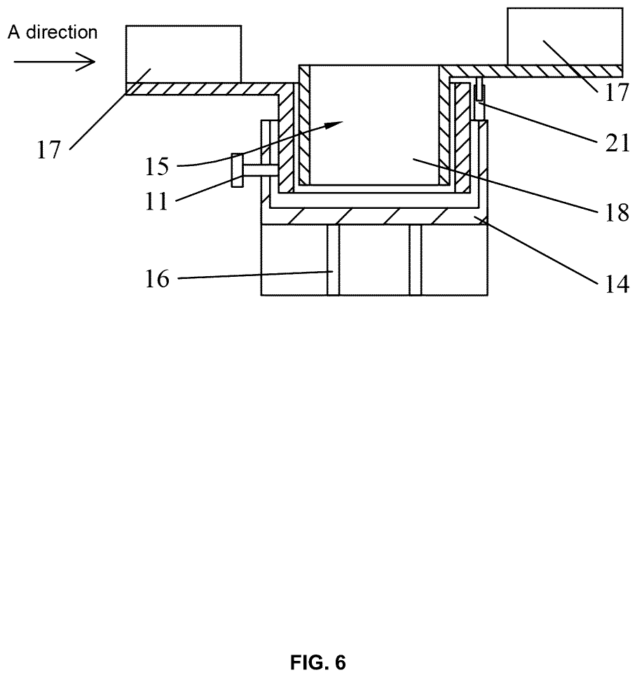

FIG. 5 is a schematic diagram illustrating a structure of a bracket according to some embodiments of the present disclosure. FIG. 6 is a schematic diagram illustrating an internal structure of a bracket according to some embodiments of the present disclosure.

In some embodiments, as illustrated in FIG. 5 and FIG. 6, a transmitting device may further comprise a bracket 9. The bracket 9 may include a cable fixing member 10, a horizontal fixing member 11, support leg pivots 12, support legs 13, and a frame 14. The cable fixing member 10 may be sleeved within the frame 14 and fixedly connected with the frame 14 through the horizontal fixing member 11. The support legs 13 may be rotationally connected with a lower end of the frame 14 through the support leg pivots 12.

The frame 14 refers to a main structure of the bracket 9. In some embodiments, the frame 14 may be provided with the cable fixing member 10 and the horizontal fixing member 11. A top of the frame 14 may be provided with an accommodating cavity 15. A bottom of the frame 14 may be provided with a plurality of reinforcing ribs 16. The support legs 13 may be hinged to the reinforcing ribs 16 through the support leg pivots 12.

The support leg pivot 12 refers to a component that connects the support leg 13 to the frame 14. For example, the support leg pivot 12 may be a pin, a bolt, or the like. In some embodiments, two ends of each of the support leg pivots 12 may be connected with the reinforcing ribs 16.

The support leg 13 refers to a support component of the frame 9. In some embodiments, a top of the support leg 13 may be provided with a through hole through which the support leg pivot 12 may pass to enable the support leg 13 to be hinged to the frame 14.

In some embodiments, three support legs 13 may be provided and hinged to the frame 14 through three support leg pivots 12. It should be understood that the bracket 9 supported by the three support legs 13 may reduce a weight of the bracket 9 while ensuring a support stability, thereby facilitating to carry and transport.

The cable fixing member 10 refers to a component for accommodating and fixing a cable.

In some embodiments, one end of the cable fixing member 10 may be provided with an elastic member 17, and another end of the cable fixing member 10 may be provided with a sleeve structure 18. The elastic member 17 may be provided on an outer side above the frame 14. The sleeve structure 18 may be provided within the frame 14.

The elastic member 17 refers to a structural member with a contraction capacity. For example, a material of the elastic member 17 may include elastic plastic, rubber, or the like. In some embodiments, the elastic member 17 may be configured to fix the cable and guide a direction of the cable.

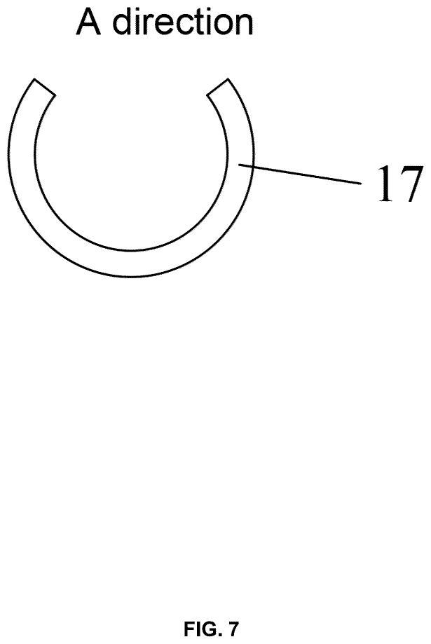

FIG. 7 is a schematic diagram illustrating an elastic member in an A direction in FIG. 6. As illustrated in FIG. 7, a cross-sectional shape of the elastic member 17 in the A direction may be in a shape of C and an opening of the cross-sectional shape of the elastic member may be upward. In some embodiments, the elastic member 17 may also be designed in another structural shape. For example, the cross-sectional shape of the elastic member 17 in the A direction may also be in a shape of U, etc.

In some embodiments, an inner diameter of the elastic member 17 may be smaller than an outer diameter of the cable. The cable may be fixed within the elastic member 17 by a contraction force of the elastic member 17.

The sleeve structure 18 refers to a component for supporting and fixing the elastic member 17. In some embodiments, as illustrated in FIG. 6, the sleeve structure 18 and the elastic member 17 may be components at different positions of an overall part. The sleeve structure 18 may be cylindrical. The frame 14 may be sleeve-shaped with a support located at a bottom of the frame 14. The sleeve structure 18 may be provided within the accommodating cavity 15 of the frame 14 and rotatably connected with the frame 14 by a gravity of the sleeve structure 18.

It should be understood that an end of the cable placed inside the sleeve structure 18 may enter from an end of the elastic member 17 close to the sleeve structure 18, and protrude from an end of the elastic member 17 away from the sleeve structure 18, so that the cables with different diameters may be clamped with an elasticity of the elastic member 17, thereby supporting the cables, and effectively preventing the cables from sagging.

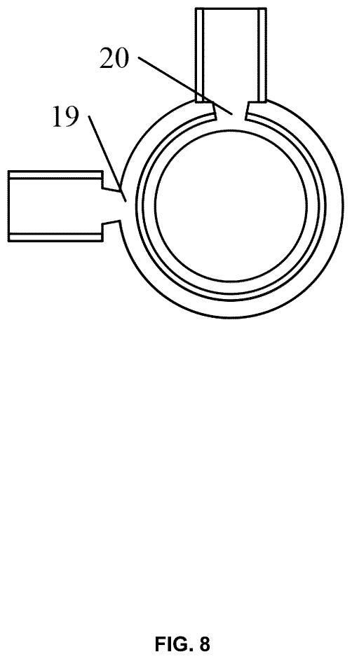

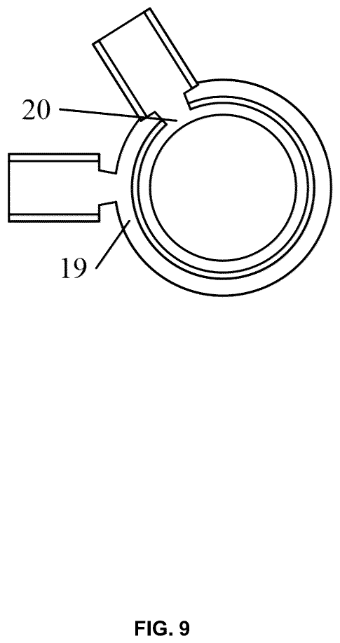

FIG. 8 is a top view illustrating a cable fixing member according to some embodiments of the present disclosure. FIG. 9 is a top view illustrating a cable fixing member after angle adjustment according to some embodiments of the present disclosure.

In some embodiments, as illustrated in FIG. 8 and FIG. 9, the cable fixing member 10 may include a first fixing member 19 and a second fixing member 20. A second sleeve structure of the second fixing member 20 may be sleeved within a first sleeve structure of the first fixing member 19. The first sleeve structure may be sleeved within the accommodating cavity 15 of the frame 14.

In some embodiments, the first sleeve structure and the second sleeve structure may rotate relative to each other.

It should be understood that by providing the first fixing member 19 and the second fixing member 20, one cable may be clamped in the first elastic member 17 of the first fixing member 19, and another cable may be clamped in the second elastic member 17 of the second fixing member 20. The two cables may be connected above the first sleeve structure and the second sleeve structure. Therefore, an angle between the two cables may be adjusted arbitrarily, and a height of a connection of two adjacent cables may also be supported and adjusted.

In some embodiments, the transmitting device may further comprise a height support member 21. The height support member 21 may be connected with the second fixing member 20 to adjust a height of the second fixing member 20.

In some embodiments, the height support member 21 may include a screw and a nut sleeve. One end of the screw may be disposed in the nut sleeve and threadedly connected with the nut sleeve, and another end of the screw may be fixedly connected with a bottom of the second fixed member 20. A bottom end of the nut sleeve may be rotationally connected with a top of the frame 14, and a centerline of a rotational shaft of the bottom end of the nut sleeve may be perpendicular to a bottom of the second fixing member 20. The nut sleeve may be configured to adjust a height of the screw.

In some embodiments, the height support member 21 may also use any other feasible structure or component, such as a hydraulic cylinder, a pneumatic cylinder, or the like.

In some embodiments, the screw and the nut sleeve may relatively rotate by rotating the nut sleeve, causing an axial relative movement between the screw and nut sleeve, thereby adjusting a spacing between the second fixing member 20 and the frame 14. When two cables are disposed in the nut sleeve, ends of the two cables may pass through the first elastic member 17 and the second elastic member 17, respectively. By adjusting the height support member 21, a relative height between the two cables may be adjusted.

The horizontal fixing member 11 refers to a component configured to horizontally fix the cable fixing member 10. The horizontal fixing member 11 may be in various structures including, but not limited to, a bolt, a screw nail, or the like.

In some embodiments, the horizontal fixing member 11 may be the screw nail. The horizontal fixing member 11 may be provided on the outer side of the frame 14. A threaded section of the horizontal fixing member 11 may extend through an outer wall of the frame 14 to an inside of the frame 14, and may be threadedly connected with the outer wall of the frame 14. One end of the horizontal fixing member 11 located inside the frame 14 may abut against an outer wall of the sleeve structure 18. When a relative position of the cable fixing member 10 and the frame 14 needs to be fixed, the horizontal fixing member 11 may be rotated to move towards the inside of the frame 14, thereby pushing the sleeve structure 18 (e.g., the first sleeve structure) to move until one side of the sleeve structure 18 away from the horizontal fixing member 11 abuts against an inner wall surface of the frame 14. In this case, the inner wall surface of the frame 14 and the horizontal fixing member 11 may jointly clamp the sleeve structure 18, thereby fixing the sleeve structure 18.

In some embodiments, the bracket 9 may be made of plastic to avoid electromagnetic interference to the transmitting device from a metallic material.

In some embodiments of the present disclosure, by providing the cable fixing member and the height support member, the angle and the relative height between the ends of the cable may be adjusted, making it convenient to provide and install the cable.

In some embodiments, according to the TEM, geophysical exploration is achieved by inversely deducing a relationship between a resistivity of a test point and a change of depth based on a curve of change in a secondary magnetic field or the secondary electric field decaying with time after power outage. It should be understood that if a transmitting magnetic moment is inaccurate, neither an intensity nor a direction of a primary magnetic field is accurate. When a transient electromagnetic field propagates into the subsurface, the transient electromagnetic field may also interact with a conductor in the subsurface to generate another secondary magnetic field, which may interfere with a variation curve of a finally received secondary magnetic field decaying with time. Therefore, the transmitting magnetic moment needs to be corrected.

In some embodiments, the transmitting device may further comprise a control terminal (not shown in the figure) and a vision sensor (not shown in the figure). The control terminal may be in communicating connection with the vision sensor. In some embodiments, the vision sensor may be configured to acquire a current surface environment image and a coil position image after a rectangular transmitting coil is laid.

In some embodiments, the control terminal may include a processor. The processor may be configured to: determine a current surface environment based on the current surface environment image; determine a laying parameter based on the current surface environment and a detection requirement; determine the transmitting magnetic moment based on the laying parameter; determine a coil position after the rectangular transmitting coil is laid based on the coil position image after the rectangular transmitting coil is laid; and correct the transmitting magnetic moment based on the coil position after the rectangular transmitting coil is laid.

A vision sensor refers to a device configured to capture an image and convert the image into data that can be processed by a computer, such as a laser scanner, a 3D sensor, or the like. In some embodiments, the vision sensor may include a lidar and an image acquisition device.

In some embodiments, the vision sensor may be used for image acquisition, image processing, and image recognition.

Current surface environment refers to a surface environment around the transmitting device, such as a ground building position, a ground vegetation position, a river position, or the like. It should be understood that the current surface environment may include a plurality of position point information and/or data.

A current surface environment image refers to image data of the surface environment around the transmitting device. In some embodiments, the current surface environment image may include a three-dimensional image and a two-dimensional image of the current surface environment.

In some embodiments, the lidar may acquire point cloud data around the transmitting device and generate the three-dimensional image of the surface environment around the transmitting device based on the point cloud data. That is, the three-dimensional image of the current surface environment may be obtained. The image acquisition device may obtain the two-dimensional image of the surface environment around the transmitting device through photography or the like. That is, the two-dimensional image of the current surface environment may be obtained.

A coil position after the rectangular transmitting coil is laid refers to an actual laying position of the coil. In some embodiments, the coil position after the rectangular transmitting coil is laid may reflect an inclination angle of the coil after the rectangular transmitting coil is laid, a planar projection shape or area of the coil after the rectangular transmitting coil is laid, etc.

A coil position image after the rectangular transmitting coil is laid refers to image data that reflects the actual laying position of the coil. In some embodiments, the coil position image after the rectangular transmitting coil is laid may include the three-dimensional image and the two-dimensional image of the coil position after the rectangular transmitting coil is laid.

In some embodiments, the three-dimensional image of the coil position after the rectangular transmitting coil is laid may be acquired by the lidar. The two-dimensional image of the coil position after the rectangular transmitting coil is laid may be acquired by the image acquisition device.

A control terminal refers to a terminal device configured to control the transmitting device. For example, the control terminal may be a laptop computer, a smartphone, an in-vehicle computer, or a control center. In some embodiments, the control terminal may be in communicating connection with other components (e.g., the vision sensor, etc.) of the transmitting device by a wired (e.g., a cable, etc.) or wireless (e.g., WiFi, Bluetooth, etc.) means.

A processor refers to a component of the control terminal capable of performing information and/or data processing. The processor may process information and/or data obtained from one or more components of other equipment or devices. The processor may execute a program instruction based on the data, the information, and/or a processing result to perform one or more of functions described in the present disclosure. In some embodiments, the processor may include one or more sub-processing devices (e.g., a single-core processing device or a multi-core processing device). Merely by way of example, the processor may include a central processing unit (CPU), an application specific integrated circuit (ASIC), or the like, or any combination thereof. In some embodiments, the processor may be deployed within a remote server.

In some embodiments, the processor may determine the current surface environment by processing and recognizing the three-dimensional image and the two-dimensional image of the current surface environment. Exemplary image processing and recognition algorithms may include a target detection algorithm (e.g., a RANSAC algorithm, a Euclidean clustering algorithm), a point cloud reconstruction algorithm (e.g., an occupancy networks algorithm), a depth estimation algorithm (e.g., a stereoscopic depth estimation algorithm, etc.).

In some embodiments, the processor may determine the coil position after the rectangular transmitting coil is laid by processing and recognizing the three-dimensional image and the two-dimensional image of the coil position after the rectangular transmitting coil is laid.

A detection requirement refers to a detection requirement that the user needs the transmitting device to fulfill. In some embodiments, the detection requirement may include a detection depth requirement and a level of electromagnetic noise interference.

A detection depth requirement refers to a depth from the surface of the earth that needs to be detected by the transmitting device. For example, the detection depth may be 50 m, 100 m, etc. In some embodiments, the detection depth requirement may be manually set by the user.

A level of electromagnetic noise interference refers to a degree to which electromagnetic noise in a detection environment interferes with a detection process. In some embodiments, the level of electromagnetic noise interference may be obtained by an electromagnetic measurement device based on a measurement of the current detection environment. The level of electromagnetic noise interference may vary depending on the detection environment.

A laying parameter refers to an individual parameter required for cable laying. In some embodiments, the laying parameter may include at least one of a side length of the transmitting coil, an angular point position of the transmitting coil, and a count of cable cores.

A side length of the transmitting coil refers to a length of each side of the transmitting coil. For example, when the transmitting coil has four sides, the side length of the transmitting coil may be a length corresponding to each of a cable I, a cable II, a cable III, and a cable IV.

A angular point position of the transmitting coil refers to a position of each inflection point (or a cable connector) of the transmitting coil relative to a ground surface. In some embodiments, the angular point position of the transmitting coil may be a spatial position.

More descriptions regarding the count of cable cores may be found in the previous descriptions.

In some embodiments, the processor may determine the laying parameter in various ways based on the current surface environment and the detection requirement. For example, the processor may determine the laying parameter by querying a first predetermined table based on the current surface environment and the detection requirement. The first predetermined table may characterize a correlation between the current surface environment, the detection requirement, and the laying parameter. The current surface environment may be different from the detection requirement and the laying parameter corresponding to the current surface environment. In some embodiments, the first predetermined table may be constructed based on historical data.

In some embodiments, the processor may determine a laying position based on the current surface environment; and the laying parameter based on the laying position and the detection requirement.

A laying position refers to a position where the cable can be laid, which is considered as a position where the cable connector is arranged. For example, the cable may cross a river, and two cable connectors may be placed on each side of the river, respectively. Positions of the two cable connectors may be considered as the laying positions.

In some embodiments, the processor may determine the laying position based on the current surface environment through a predetermined determination criterion. For example, the processor may classify position points in the current surface environment as the laying positions and no-laying positions based on the predetermined determination criterion, and denote the laying positions and the no-laying positions with 1 and 0, respectively.

The predetermined determination criterion may be a manually determined criterion for laying determination. In some embodiments, the predetermined determination criterion may include that whether a surface depth or a surface height of a position point exceeds a threshold, or whether a difference between surface depths or surface heights of two adjacent position points exceeds a difference threshold. The threshold and the difference threshold may be predetermined empirically. For example, if the surface depth or the surface height does not exceed the threshold (or is equal to the threshold), the position point may be considered as the laying point. As another example, if the difference between the surface depths or the surface heights of the two adjacent position points exceeds the difference threshold, the two position points may be considered as the no-laying positions. The surface depth (or the surface height) of the position point may reflect a distance difference between a surface of the position point and the ground surface. It should be understood that the greater the surface depth (or the surface height) is, the greater the distance difference between the surface of the position point and the ground surface is.

In some embodiments, the processor may use the laying positions that satisfy a predetermined laying condition as the angular point positions of the transmitting coil based on the laying positions in combination with the side length (e.g., the side length of the of the transmitting coil may be L) of the transmitting coil. A predetermined laying condition refers to a predetermined condition for filtering the angular point positions of the transmitting coil. For example, the predetermined laying condition may include that four angular point positions of the transmitting coil may be connected to form a square of which the side length of the of the transmitting coil of L.

It should be noted that when the angular point positions of the transmitting coil are selected, the four angular point positions of the transmitting coil are ensured to be in a same plane as much as possible. If the four angular point positions of the transmitting coil are not in the same plane, the height difference between the four angular point positions of the transmitting coil should be selected as small as possible. Meanwhile, the level of electromagnetic noise interference may also be comprehensively considered, thereby ensuring that the level of electromagnetic noise interference is within a predetermined interference level range.

In some embodiments, the processor may determine the side length of the transmitting coil and the count of cable cores based on the detection requirement through vector matching. For example, a database may include a plurality of reference vectors. Each of the plurality of reference vectors may include a corresponding side length of the transmitting coil and a corresponding count of cable cores. The plurality of reference vectors may be constructed based on historical detection requirements in the historical data.

In some embodiments, the processor may construct vectors to be matched based on the detection requirement (e.g., the detection depth requirement and the level of electromagnetic noise interference).

In some embodiments, the processor may separately calculate a distance between each of the plurality of reference vectors and each of the vector to be matched, determine a reference vector whose distance from the vector to be matched satisfies a predetermined distance condition as a target vector, and determine the side length of the transmitting coil and the count of cable cores corresponding to the target vector as the side length of the transmitting coil and the count of cable cores corresponding to the vector to be matched. The predetermined distance condition may be set based on an actual situation. For example, the predetermined distance condition may be that a vector distance is minimal or the vector distance is less than a certain threshold, etc.

According to some embodiments of the present disclosure, the influence of the angular point positions of the transmitting coil on geophysical exploration may be considered, so that the lengths of the cables and the count of cable cores may be set more accurately. In this way, errors in setting of the lengths of the cables and the count of cable cores may not occur easily, avoiding cable waste, and ensuring the accuracy and reliability of the detection results.

In some embodiments, the laying parameter may further include a bracket height, a bracket use, and a bracket position. More descriptions regarding the bracket may be found in the related descriptions above (e.g., FIG. 5-FIG. 6 and related descriptions thereof).

A bracket height refers to a height from the a top of the bracket at the angular point position of the transmitting coil where the bracket is provided to the ground. In some embodiments, when a plurality of angular point positions of the transmitting coil are in the same plane or the height differences between the plurality of angular point positions of the transmitting coil are within a predetermined range after a predetermined count of brackets are provided, heights of brackets corresponding to the plurality of angular point positions of the transmitting coil may be considered as the bracket height.

The predetermined count may be set by the user. In some embodiments, the predetermined count may be no more than 2 to prevent cumbersome installation caused by an excessive count of brackets.

A bracket use refers to different positions where the bracket is used to support the transmitting coil. In some embodiments, the bracket may be classified as an annular point use bracket and a side use bracket based on different use positions.

The annular point use bracket may be configured to support an angular point of the transmitting coil. In some embodiments, the annular point use bracket may include two cable fixing members which support two cables located at the angular point of the transmitting coil, respectively. The angular point of the transmitting coil is a connection of two cables. The annular point use bracket may form good support and clamping for the two cables.

A side use bracket refers to a bracket used to support a side of the transmitting coil. In some embodiments, the side use bracket may include two cable fixing members. When the side (e.g., a middle position of the cable) of the transmitting coil is supported using the side use bracket, the cable may be supported using only one of the two cable fixing members. In some embodiments, the side use bracket may also include only one cable fixing member, which may be used to fix the side (e.g., the middle position of the cable) of the transmitting coil. When a suspension distance of the middle position of the cable is too long, the edge use bracket may be erected at a suspension position the cable to support the cable, preventing excessive tension at two end connections of the cable. For example, when the side length of the transmitting coil is 20 m and the side of the transmitting coil has the suspension position, the side use bracket may be arranged at a center of the suspension position, such as at a 10-meter point in the middle position.

A bracket position refers to a location where the bracket is installed. In some embodiments, the laying position may include the bracket position.

In some embodiments, the bracket position may be determined based on the bracket use. For example, when the bracket is the angular point use bracket, the bracket position may be located at the angular point of the transmitting coil. As another example, when the bracket is the side use bracket, the bracket position may be located at a specific position (e.g., the middle position) on the side of the transmitting coil. It should be understood that if at least one side bracket is simultaneously arranged on one side of the transmitting coil, the bracket position may be located on at least one position on the side of the transmitting coil.

According to some embodiments of the present disclosure, a laying process of the transmitting coil may be more accurate by obtaining the laying parameter including the bracket height, the bracket use, and the bracket position.

A transmitting magnetic moment refers to a parameter that describes an intensity of a magnetic field generated by the transmitting coil.

In some embodiments, the transmitting magnetic moment may be related to a return line area and a transmitting current. A return line area refers to an area of a pattern enclosed by the transmitting coil. A transmitting current refers to a working current of the transmitting coil during a transmitting phase.

In some embodiments, the transmitting magnetic moment may be positively correlated with the return line area and the transmitting current. For example, the transmitting magnetic moment=the transmitting current×the return line area.

In some embodiments, the processor may calculate the return line area based on the laying parameter. For example, the processor may determine a pattern (e.g., a square) enclosed by the transmitting coil based on the angular point position of the transmitting coil in the laying parameter, and then calculate the return line area (e.g., return line area S=L²) using an area calculation formula based on the side length (e.g., side length of the transmitting coil may be L) of the transmitting coil in the laying parameter.

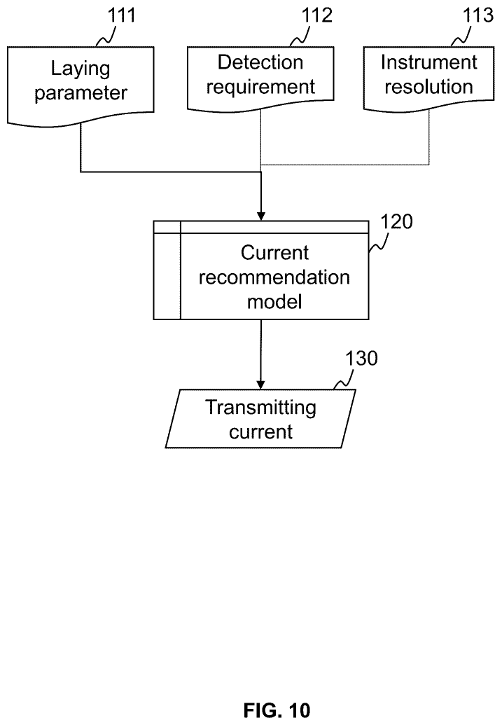

In some embodiments, the processor may determine the transmitting current by querying a second predetermined table based on the laying parameter. The second predetermined table may characterize a correlation between the laying parameter and the transmitting current. Different laying parameters may characterize different transmitting currents corresponding to different laying parameters. In some embodiments, the second predetermined table may be constructed based on historical data. More descriptions regarding determining the transmitting current based on the laying parameter may be found in FIG. 10 and related descriptions thereof.

In some embodiments, due to a certain deviation between the coil position after the transmitting coil is laid and the laying parameter, when the coil position after the transmitting coil is laid changes, the angular point position of the transmitting coil may not be in the same plane, thus causing a difference between an actual return line area after the transmitting coil is laid and the return line area calculated by the laying parameter, which in turn affects the transmitting magnetic moment and ultimately the detection accuracy. Therefore, the transmitting magnetic moment may be corrected by determining the actual return area after the transmitting coil is laid.

In some embodiments, the processor may determine the actual return line area after the transmitting coil is laid based on the coil position after the transmitting coil is laid; determine a correction coefficient based on the actual return line area; and correct the transmitting magnetic moment based on the correction coefficient. Descriptions regarding the definition of the coil position after the transmitting coil is laid and the manner of obtaining the coil position after the transmitting coil is laid may be found in the previous descriptions.

In some embodiments, in response to determining that the angular point position (actual position) of the transmitting coil after the transmitting coil is not in the same plane, the processor may determine the correction coefficient based on a ratio of the actual return line area to the return line area, and correct the transmitting magnetic moment based on the correction coefficient.

An actual return line area after the transmitting coil is laid refers to an area of a pattern enclosed by the coil after the transmitting coil is laid, such as an area of a planar quadrilateral or a planar pentagon.

In some embodiments, since the pattern enclosed by the transmitting coil is typically a quadrilateral (e.g., a square), the vision sensor may obtain coordinates of quadrilateral vertices based on the angular point positions of the coil after the transmitting coil is laid and calculate an area of the quadrilateral using a vector cross product method. A formula for calculating the actual return line area may be denoted as S=0.5·|\vec{AB}×\vec{AC}|+0.5·|\vec{AC}×\vec{AD}|, wherein S denotes the actual return line area, A, B, C and D denote the four quadrilateral vertices, AC denotes a diagonal, \vec{AB} denotes a vector from a point A to a point B, \vec{AC} denotes a vector from the point A to a point C, \vec{AD} denotes a vector from the point A to a point D, x denotes a cross product operation of vectors, and | . . . | denotes a mode or a length of a vector.

A correction coefficient refers to a coefficient for correcting the transmitting magnetic moment. In some embodiments, the correction coefficient may be correlated with the actual return line area after the transmitting coil is laid and a conversion coefficient. Merely by way of example, the formula for calculating the correction coefficient may be denoted as follows: correction coefficient=actual return line area after the transmitting coil is laid/return line area×conversion coefficient. The conversion coefficient may be obtained by calculation or based on experience.

In some embodiments, the processor may use a product of the correction coefficient and the transmitting magnetic moment as a corrected transmitting magnetic moment. For example, when the correction coefficient is 0.75, the corrected transmitting magnetic moment may be 0.75 times the transmitting magnetic moment.

It should be understood that the transmitting magnetic moment may be corrected by the coil position after the transmitting coil is laid, so that the transmitting magnetic moment may be more realistic, thereby facilitating the detection accuracy.

According to some embodiments of the present disclosure, by determining the transmitting magnetic moment based on the current surface environment and the detection requirement, and by correcting the transmitting magnetic moment by further considering the influence of the coil position after the transmitting coil is laid on the transmitting magnetic moment, the transmitting magnetic moment of the transmitting device may be more accurate, thereby effectively improving the detection accuracy.

FIG. 10 is a schematic diagram illustrating an exemplary current recommendation model according to some embodiments of the present disclosure. As illustrated in FIG. 10, a processor may determine a transmitting current 130 based on a laying parameter 111, a detection requirement 112, and an instrument resolution 113 through a current recommendation model 120.

A current recommendation model refers to a model used to recommend the transmitting current for a coil. In some embodiments, the current recommendation model may be a machine learning model. For example, the current recommendation model may include deep neural networks (DNN), convolutional neural networks (CNN), or the like, or any combination thereof.

In some embodiments, an input of the current recommendation model may include the detection requirement (e.g., a detection depth requirement, and a level of electromagnetic noise interference), a laying parameter, and the instrument resolution, and an output of the current recommendation model may include the transmitting current.

An instrument resolution refers to a detection accuracy of an instrument. In some embodiments, the instrument resolution may be obtained based on user input.

In some embodiments, the current recommendation model may be obtained by training. A training sample may include a sample level of electromagnetic noise interference, a sample laying parameter, a sample instrument resolution sequence, and an actual detection depth corresponding to the sample instrument resolution sequence. A labels may include an actual detection effect corresponding to the training sample.

In some embodiments, the training sample may be obtained based on historical data.

In some embodiments, the label corresponding to the training sample may be obtained based on the sample level of electromagnetic noise interference and the actual detection depth corresponding to the sample instrument resolution sequence. For example, a transmitting current used for an optimal detection effect achieved by the transmitting device at the sample level of electromagnetic noise interference and at the actual detection depth corresponding to the sample instrument resolution sequence may be the label corresponding to the training sample.

The detection effect may reflect a degree of excellence of electromagnetic field data detected by the transmitting device. In some embodiments, the detection effectiveness may be measured based on objective metrics. For example, at a certain transmitting current, a decay process of magnetic field data or electric field data obtained after power outage may be relatively clear and low in noise, which may be determined that the detection effect is superior.

In some embodiments, the processor may input the training samples into an initial current recommendation model, iteratively update parameters of the initial current recommendation model through training until a trained model satisfies a preset training condition, and obtain a trained current recommendation model. The preset training condition may be that a loss function is less than a threshold, converges, or a training period reaches a threshold. In some embodiments, a manner of iteratively updating the the parameters of the model may include a conventional model training method such as stochastic gradient descent.

In some embodiments of the present disclosure, the transmitting current may be recommended through the trained current recommendation model, thereby obtaining a more accurate transmitting magnetic moment, and improving the detection accuracy of the transmitting device.

The basic concept has been described above. Obviously, for those skilled in the art, the above detailed disclosure is only an example, and does not constitute a limitation to the present disclosure. Although not expressly stated here, those skilled in the art may make various modifications, improvements and corrections to the present disclosure. Such modifications, improvements and corrections are suggested in this disclosure, so such modifications, improvements and corrections still belong to the spirit and scope of the exemplary embodiments of the present disclosure.

What is claimed is:

1. A separated multi-core transmitting device based on a ground transient electromagnetic method, comprising: a rectangular transmitting coil, wherein the rectangular transmitting coil includes a cable I, a cable II, a cable III, and a cable IV, each of the cable I, the cable II, the cable III, and the cable IV is provided with N wires, two ends of each of the N wires is provided with a sub connector and a female connector, respectively, the sub connectors of the wires within each cable are labeled sequentially with uppercase letters, and the female connectors of the wires within the each cable are labeled sequentially with lower case letters; the sub connectors are connected with sub connector interfaces, the female connectors are connected with female connector interfaces, and the sub connector interfaces and the female connector interfaces are detachably connected; and
the sub connectors of the cable I are connected with the female connectors of same letters of the cable II, the sub connectors of the cable II are connected with the female connectors of same letters of the cable III, the sub connectors of the cable III are connected with the female connectors of same letters of the cable IV, and the sub connectors of the cable IV are connected with the female connectors of next letters of same letters of the cable I; and a first wire of the female connectors of the cable I is led out to serve as a positive electrode of a transient electromagnetic instrument transmitter, and a last wire of the sub connectors of the cable IV is led out to serve as a negative electrode of the transient electromagnetic instrument transmitter.

2. The separated multi-core transmitting device of claim 1, wherein a size of the rectangular transmitting coil is adjusted by lengths of the cable I, the cable II, the cable III, and the cable IV to adapt to different detection depths.

3. The separated multi-core transmitting device of claim 2, wherein a protective sleeve is provided on each sub connector interface and each female connector interface, respectively.

4. The separated multi-core transmitting device of claim 1, wherein when a detection depth is 25 m, the cable I, the cable II, the cable III, and the cable IV are cables with a length of 5 m, and a count of cable cores is selected as 5.

5. The separated multi-core transmitting device of claim 1, wherein when a detection depth is 50 m, the cable I, the cable II, the cable III, and the cable IV are cables with a length of 5 m, and a count of cable cores is selected as 10; or the cable I, the cable II, the cable III, and the cable IV are cables with a length of 10 m, and a count of cable cores is selected as 5.

6. The separated multi-core transmitting device of claim 1, wherein when a detection depth is 100 m, the cable I, the cable II, the cable III, and the cable IV are cables with a length of 5 m, and a count of cable cores is selected as 20; or the cable I, the cable II, the cable III, and the cable IV are cables with a length of 10 m, and a count of cable cores is selected as 10.

7. The separated multi-core transmitting device of claim 1, wherein when a detection depth is 200 m, the cable I, the cable II, the cable III, and the cable IV are cables with a length of 10 m, and a count of cable cores is selected as 20; or the cable I, the cable II, the cable III, and the cable IV are cables with a length of 20 m, and a count of cable cores is selected as 10.

8. The separated multi-core transmitting device of claim 1, further comprising a control terminal and a vision sensor, wherein the control terminal is in communicating connection with the vision sensor;
the vision sensor is configured to acquire a current surface environment image and a coil position image after the rectangular transmitting coil is laid;
the control terminal includes a processor, and the processor is configured to:
determine, based on the current surface environment image, a current surface environment;
determine, based on the current surface environment and a detection requirement, a laying parameter;
determine, based on the laying parameter, a transmitting magnetic moment, the transmitting magnetic moment being related to a return wire area and a transmitting current;
determine, based on the coil position image after the rectangular transmitting coil is laid, a coil position after the rectangular transmitting coil is laid; and
correct, based on the coil position after the rectangular transmitting coil is laid, the transmitting magnetic moment.

9. The separated multi-core transmitting device of claim 8, wherein the laying parameter includes at least one of a side length of the rectangular transmitting coil, an angular point position of the rectangular transmitting coil, and a count of cable cores.

10. The separated multi-core transmitting device of claim 9, wherein the laying parameter further includes a bracket height, a bracket use, and a bracket position.

11. The separated multi-core transmitting device of claim 9, wherein the processor is further configured to:
determine, based on the current surface environment, a laying position; and
determine, based on the laying position and the detection requirement, the laying parameter.

12. The separated multi-core transmitting device of claim 11, wherein the processor is further configured to:
determine, based on the laying parameter, the detection requirement, and an instrument resolution, the transmitting current through a current recommendation model, the current recommendation model being a machine learning model.

13. The separated multi-core transmitting device of claim 12, wherein the processor is further configured to:
determine, based on the coil position after the rectangular transmitting coil is laid, an actual return wire area after the rectangular transmitting coil is laid;
determine, based on the actual return wire area, a correction coefficient; and
correct, based on the correction coefficient, the transmitting magnetic moment.

14. The separated multi-core transmitting device of claim 1, further comprising a bracket, wherein the bracket includes a cable fixing member, a horizontal fixing member, support leg pivots, support legs, and a frame;
the cable fixing member is sleeved within the frame and fixedly connected with the frame through the horizontal fixing member; and
the support legs are rotationally connected with a lower end of the frame through the support leg pivots.

15. The separated multi-core transmitting device of claim 14, wherein one end of the cable fixing member is provided with an elastic member, and another end of the cable fixing member is provided with a sleeve structure.

16. The separated multi-core transmitting device of claim 15, wherein the cable fixing member includes a first fixing member and a second fixing member, a second sleeve structure of the second fixing member is sleeved within a first sleeve structure of the first fixing member, and the first sleeve structure is sleeved within the frame.

17. The separated multi-core transmitting device of claim 16, further comprising a height support member, wherein the height support member is connected with the second fixing member for adjusting a height of the second fixing member.
